(19) United States
(12) Patent Application Publication
(10) Pub. No.: US 2017/0275937 A1
(43) Pub. Date: Sep. 28, 2017

(54) HINGED DOOR FOR SPACE UTILIZATION

(71) Applicant: Seungkyu Park, Seoul (KR)

(72) Inventor: Seungkyu Park, Seoul (KR)

(21) Appl. No.: 15/502,504

(22) PCT Filed: Aug. 7, 2015
(86) PCT No.: PCT/KR2015/008294

§ 371 Date: May 12, 2017

(30) Foreign Application Priority Data
Aug. 8, 2014 (KR) 10-2014-0102551

(51) Int. Cl. E05D 15/58; E06B 3/48; E06B 3/92

(52) U.S. Cl. CPC E05D 15/58; E06B 3/92; E06B 3/48; E05D 2015/585; E05Y 2900/132

(57) ABSTRACT

The present disclosure relates to a hinged door for utilizing space. The hinged door includes a hinge installed at one side of an opening of a structure; a door of which one end is connected to the hinge to open and close the opening in a hinged manner, and configured to be divided into a plurality of unit panels, each unit panel connected slidably to an adjacent unit panel in an opening/closing direction to stretch/retract in the opening/closing direction; and a connection link of which a first hinge axis of one end is connected to the structure and of which a second hinge axis of the other end is connected to the unit panel of a distal end, of the plurality of unit panels, so that a length of the door is stretched/retracted in the process of hinge opening/closing the door, thereby providing a hinged door for utilizing space.

### FIELD

The present disclosure relates to a hinged door for utilizing space, and more specifically, to a hinged door for utilizing space, capable of reducing a radius of rotation of the door to make better use of space, and capable of protecting indoor privacy.

### BACKGROUND

Entrance doors can be generally classified into two types: a hinged door that may be rotated by a hinge, and a sliding door that moves in a straight line along a groove or a rail formed on a door frame.

The hinged door has a simple door frame structure, and fewer constraints for being installed, but when it is not locked, there may be cases where it is drastically opened or closed by wind pressure, thereby generating loud noises, or where it clashes with a person who is entering or exiting through the door, thereby injuring the person, and further, there is limitation in using the space surrounding the entrance door due to the radius of rotation at which the door may be opened and closed.

Further, a sliding door has a complicated door frame structure and thus constraints for being installed, and during closing the sliding door, accidents may occur where in particular a child's finger and the like gets caught between a door leaf and the door frame.

As a conventional entrance door that may be opened and closed by a hinge and that is stretchable/retractable at the same time, there is Japanese Laid-open Patent No. 10-131648 as illustrated in FIG. 1, that discloses a door where pantograph type links 12 are disposed in two lines of an upper line and a lower line that are connected to a longitudinal muntin 1 such that rotation of the links in the upper line and the lower line by a hinge can be freely contracted and stretched/retracted at the same time, and there is another type of conventional hinged entrance door for utilizing space disclosed in Japanese Laid-open Patent No. 9-078966 as illustrated in FIG. 2, which is a stretchable/retractable door having a stretchable/retractable pantograph apparatus 10 where numerous longitudinal frame materials 7, 8 and numerous inclined bars 16, 17 disposed in a stretchable/retractable direction of the door are combined, and that is formed to be rotatable by a hinge 11.

However, although the aforementioned type of stretchable/retractable doors could be used to limit access to construction sites or to prevent crimes by use of longitudinal frame materials and inclined materials and the like, they could not be used as indoor entrance doors that block a ventilation of external air or protect an indoor privacy.

### SUMMARY

### Technical Problems to be Solved

Therefore, a purpose of the present disclosure is to solve the aforementioned problems of prior art, that is, to provide a hinged door for utilizing space, that is capable of reducing a radius of rotation of the door to make better use of space.

Further, another purpose of the present disclosure is to provide a hinged door for utilizing space, where ends of a plurality of unit panels overlap each other in a state where the door is completely closed, thereby protecting indoor privacy.

Further, another purpose of the present disclosure is to provide a hinged door for utilizing space, where each coupling surface connected slidably between a plurality of unit panels in an opening/closing direction is configured as an inclined surface, and the plurality of unit panels are disposed side by side in a row in a state where the door is complete closed, thereby minimizing the thickness of the door and at the same time maintaining a relatively constant thickness of the door even when the number of the door panels increases.

Further, another purpose of the present disclosure is to provide a hinged door for utilizing space, where an extension piece is provided integrally with a hinge so that a connection link may be connected thereto, thereby allowing the door to be applied even to a wall body structure where its ceiling portion is open just as in a public bathroom.

### Technical Solution

The aforementioned purposes are achieved by a hinged door for utilizing space according to the present disclosure that includes a hinge installed at one side of an opening of a structure; a door of which one end is connected to the hinge so as to open and close the opening in a hinged manner as the door is rotated by the hinge, and which is configured to be divided into a plurality of unit panels, each unit panel being slidably connected to an adjacent unit panel in an opening/closing direction so as to stretch/retract in the opening/closing direction; and a connection link which has a first hinge axis connected to the structure at one end of the connection link and a second hinge axis connected to the unit panel arranged at a distal end of the door at the other end so that a length of the door is stretched/retracted during an opening/closing of the door.

Here, it is preferable that the first hinge axis at the one end of the connection link is disposed on a second segment that extends in a direction towards the hinge from a midpoint of a first segment that connects a position of the second hinge axis in a state where the door is completely spread and a position of the second hinge axis in a state where the door is completely folded and the second segment is perpendicular to the first segment.

Further, it is preferable that each of the plurality of unit panels has a slidably connected surface, and the surface is configured to be an inclined surface such that the plurality of unit panels are disposed side by side in a row in a state where the door closed the opening.

Further, it is preferable that the plurality of unit panels are configured such that ends of one pair of adjacent unit panels overlap each other in a state where the door closed the opening.

Further, it is preferable that a rail is formed in the opening/closing direction of the door on one of the inclined surfaces of the plurality of unit panels connected slidably to each other, and a sliding block that slides on the rail is formed on the other one of the inclined surfaces.

Further, it is preferable that the hinge includes a first fixed piece fixed to one side of the opening of the structure and a second fixed piece rotatably coupled to the first fixed piece and fixed to the door, and an extension piece to which the first hinge axis of the connection link is rotatably connected is integral with the first fixed piece.

Further, it is preferable that the extension piece consists of a vertical member that extends in a vertical direction from the first fixed piece and a horizontal member that extends in an horizontal direction from an end of the vertical member and that has an end to which the first hinge axis is connected, and the horizontal member is detachably coupled to the vertical member so that an installation direction is adjusted.

Further, it is preferable that a rail groove is formed on the horizontal member along a length of the horizontal member, and the first hinge axis of the connection link is slidably connected to the rail groove.

Further, it is preferable that the hinged door for utilizing space further includes a rail groove disposed between the hinge and the first hinge axis and fixed to the structure, and the first hinge axis of the connection link is slidably connected to the rail groove.

### Effects

According to the present disclosure, there is provided a hinged door for utilizing space, that is capable of reducing a radius of rotation of the door to make better use of space.

Further, there is provided a hinged door for utilizing space, where ends of a plurality of unit panels overlap each other in a state where the door is completely closed, thereby protecting indoor privacy.

Further, there is provided a hinged door for utilizing space, where each coupling surface connected slidably between a plurality of unit panels in an opening/closing direction is configured as an inclined surface, and the plurality of unit panels are disposed side by side in a row in a state where the door is complete closed, thereby minimizing the thickness of the door and at the same time maintaining a relatively constant thickness of the door even when the number of the door panels increases.

Further, there is provided a hinged door for utilizing space, where an extension piece is provided integrally with a hinge so that a connection link may be connected thereto, thereby allowing the door to be applied even to a wall body structure where its ceiling portion is open just as in a public bathroom.

### BRIEF DESCRIPTION OF THE DRAWINGS

FIGS. 1 and 2 are views illustrating a conventional entrance door that may be opened/closed by a hinge and that is stretchable/retractable at the same time.

FIG. 3 is a perspective view of a hinged door for utilizing space of the present disclosure.

FIG. 4 is an exploded perspective view of the hinged door for utilizing space of the present disclosure.

FIG. 5 is a plan configuration view illustrating a state where the door of the hinged door for utilizing space of the present disclosure is closed.

FIG. 6 is a cross-sectional view illustrating a state where a plurality of unit panels constituting the door of the hinged door for utilizing space of the present disclosure are coupled.

FIG. 7 is a plan configuration view illustrating a state where the door of the hinged door for utilizing space of the present disclosure is open.

FIG. 8 is a partial perspective view of a hinge according to a second embodiment of the hinged door for utilizing space of the present disclosure.

FIG. 9 is a perspective view illustrating interactions of the hinge according to the second embodiment of the hinged door for utilizing space of the present disclosure.

FIG. 10 is a plan configuration view illustrating a third embodiment of the hinged door for utilizing space of the present disclosure.

FIGS. 11 to 12 are interaction views of the third embodiment of the hinged door for utilizing space of the present disclosure.

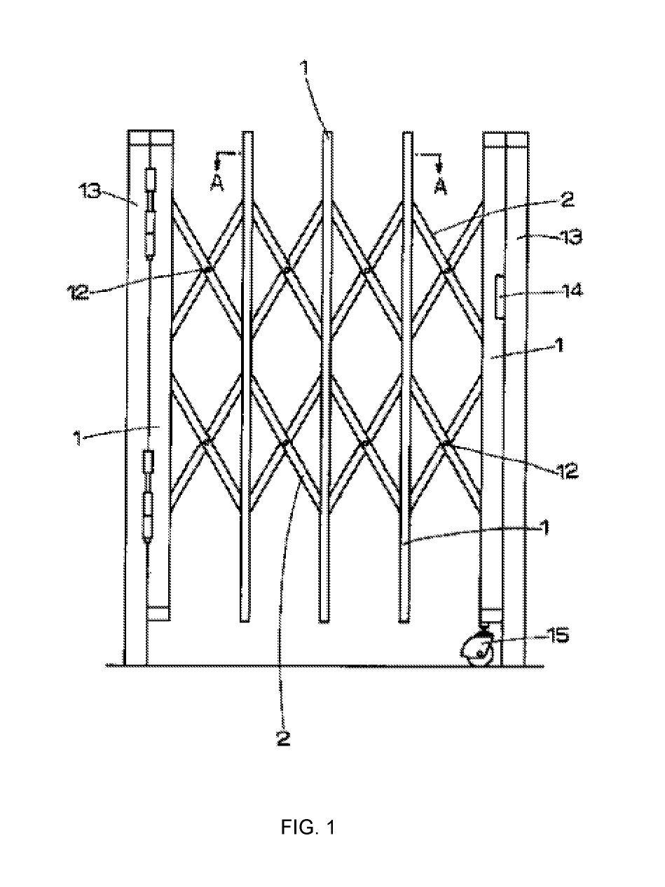

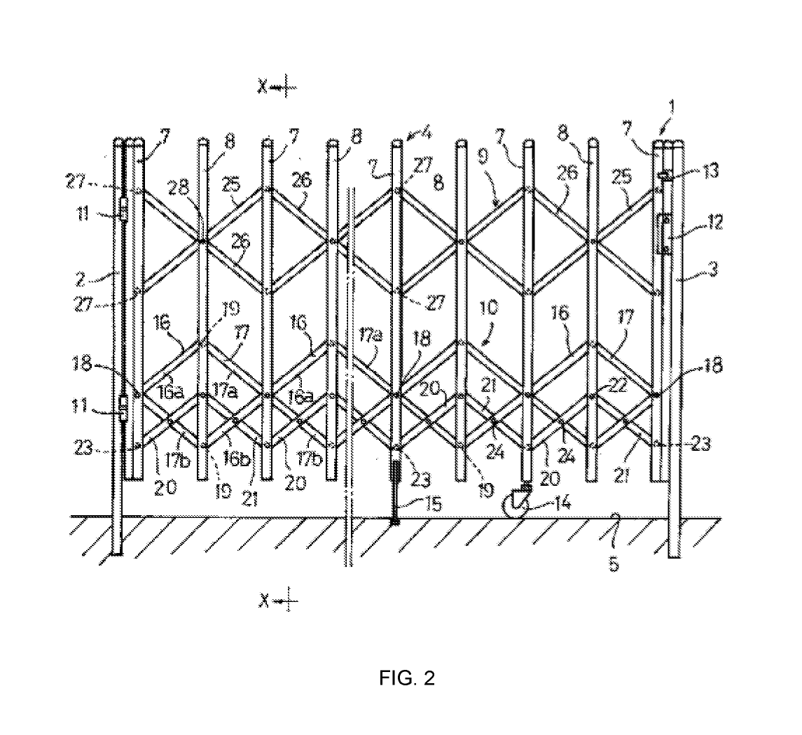

### DETAILED DESCRIPTION

Prior to describing the present disclosure, it is to be noted that in the various embodiments, like configurations use like reference numerals in the first embodiment as a representative description, and in the remaining embodiments, only the configurations that are different from those in the first embodiment will be described.

Hereinafter, a hinged door for utilizing space according to the first embodiment of the present disclosure will be described in detail with reference to the drawings attached.

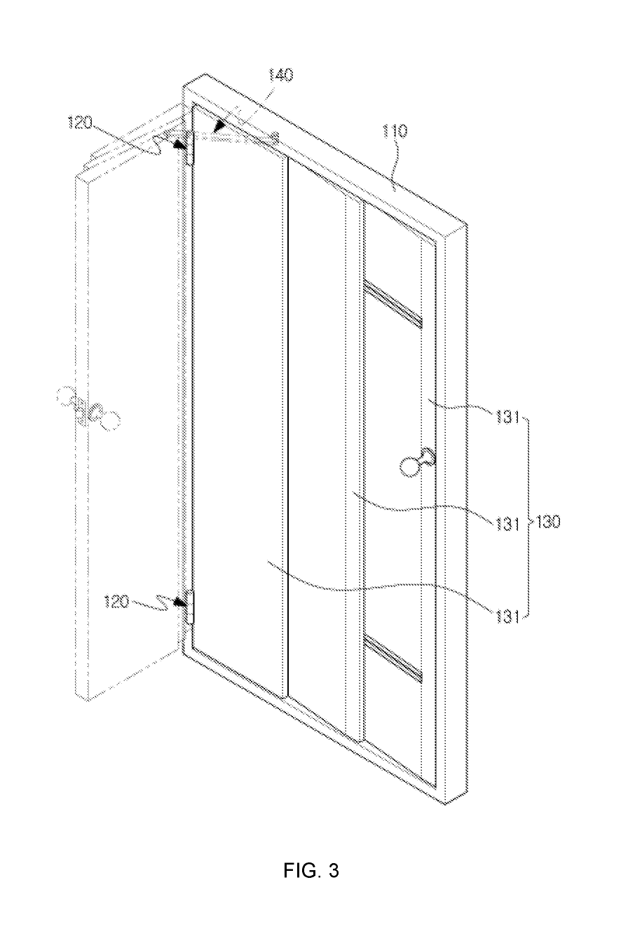

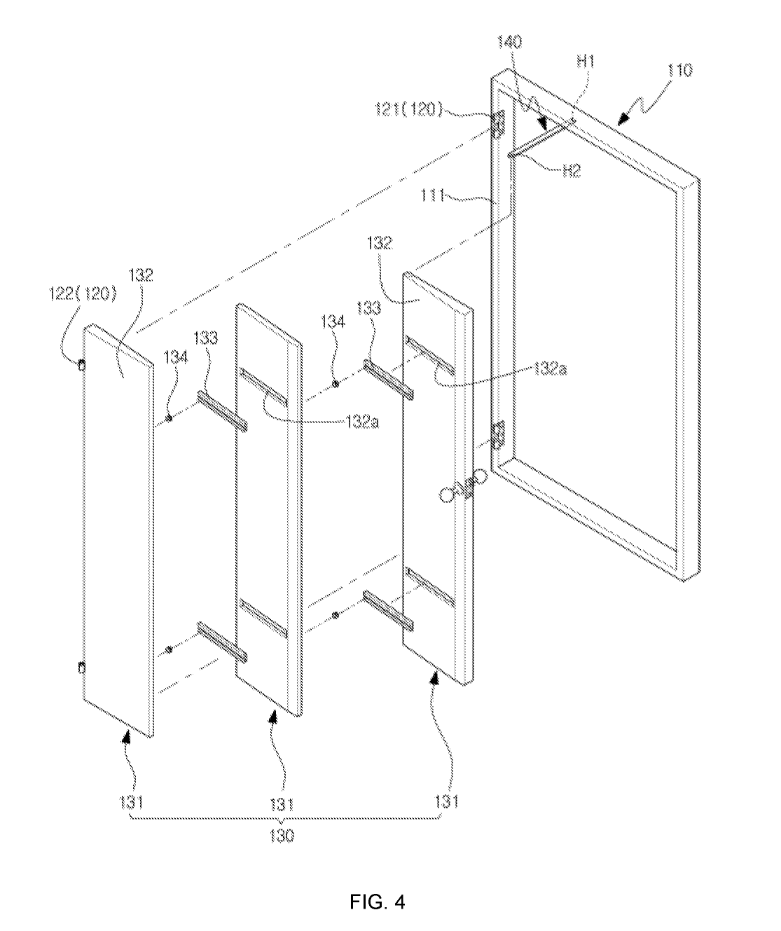

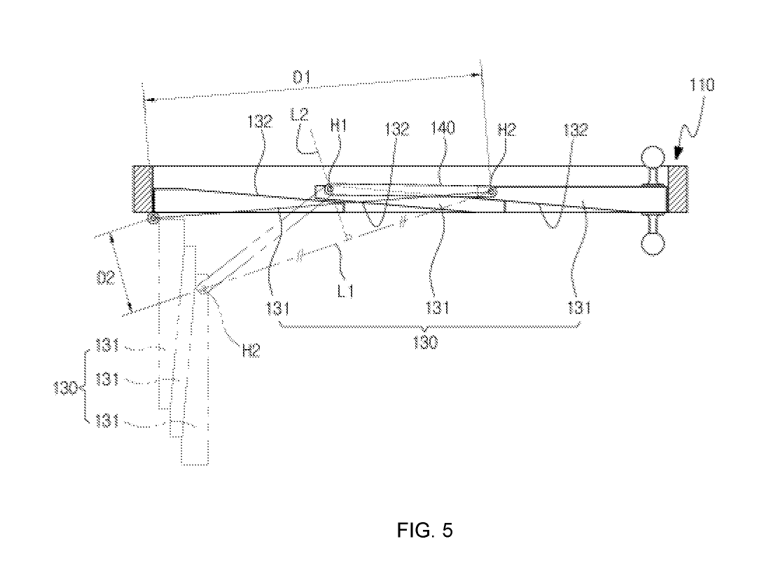

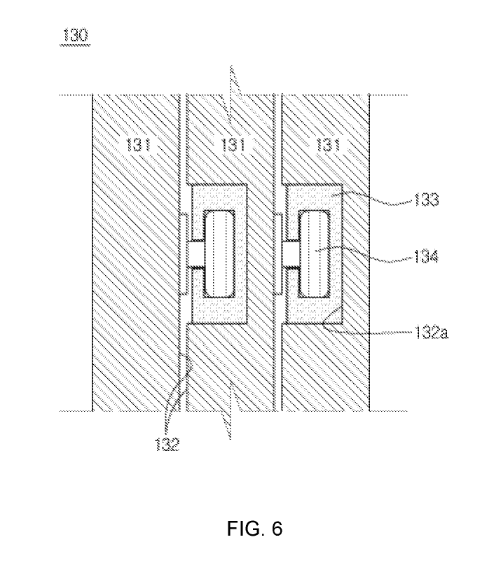

Of the drawings attached, FIG. 3 is a perspective view of the hinged door for utilizing space of the present disclosure, FIG. 4 is an exploded perspective view of the hinged door for utilizing space of the present disclosure, FIG. 5 is a plan configuration view illustrating a state where the door of the hinged door for utilizing space is closed, and FIG. 6 is a cross-sectional view illustrating a state where a plurality of unit panels constituting the door of the hinged door for utilizing space of the present disclosure are coupled.

The hinged door for utilizing space of the present disclosure as that illustrated in the aforementioned drawings includes a door frame 110, a hinge 120, a hinged type stretchable/retractable door 130, and a connection link 140.

The door frame 110 includes a plurality of supports 111 to be installed on an inner rim of an opening of a wall body structure.

The hinge 120 includes a first fixed piece 121 fixed to the support 111 at one side of the door frame 110, and a second fixed piece 122 rotatably coupled to the first fixed piece 121 and fixed to the door 130.

The door 130 has one end connected to the hinge 120 so that it may open and close the opening in a hinged manner as it is rotated by the hinge 120, and is divided into a plurality of unit panels 131. Each unit panel 131 is connected slidably to an adjacent unit panel 131 in an opening/closing direction so as to be stretchable/retractable in the opening/closing direction.

In such a plurality of unit panels 131, each of the slidably connected surface is formed in an inclined surface 132 in order to prevent imbalance of the thickness of the door 130, and the unit panels 131 are disposed side by side in a row in a state where the door 130 closed the opening, and on one of the inclined surfaces 132 connected slidably to each other, a rail 133 is formed in the opening/closing direction of the door 130, and on the other one of the inclined surfaces 133, a sliding block 134 is formed that slides along the rail 133 in a state where it is engaged with the rail 133.

Further, the rail 133 is installed in a concave installation groove 132a of the inclined surface 132 at one side of one pair of unit panels 131 that face each other, and may thus minimize a gap between the inclined surfaces 132 of the one pair of unit panels 131 that face each other.

Further, ends of one pair of adjacent unit panels 131 are disposed to overlap each other in a thickness direction of the door 130 so as to protect indoor privacy in a state where the door 130 closed the opening.

Meanwhile, although the present embodiment was described by way of an example where the door 130 is divided into three unit panels 131, there is no limitation thereto, and thus the number into which the door is divided may be varied according to the size of the door 130 or the width of the opening.

A first hinge axis H1 at one end of the connection link 140 is connected to the door frame 110 or to a structure in which the door frame 110 is installed, and a second hinge axis H2 at the other end of the connection link 140 is connected to the unit panel 131 arranged at a distal end of the door 130, so that the length of the door 130 may be stretched/retracted in the process of opening and closing the door 130.

Here, the first hinge axis H1 at the one end of the connection link 140 is disposed on a second segment L2 that extends in a direction towards the hinge 120 from a midpoint of a first segment L1 that connects a position of the second hinge axis H2 in a state where the door 130 is completely spread and a position of the second hinge axis H2 in a state where the door 130 is completely folded, and the second segment L2 is perpendicular to the first segment L1.

That is, the gap between the hinge 120 and the second hinge axis H2 in a state where the door 130 is closed is D1, and the gap between the hinge 120 and the second hinge axis H2 in a state where the door 130 is open is D2 which is shorter than D1. Therefore, the length of plurality of unit panels 131 connected slidably to each other is adjusted as the plurality of unit panels 131 are slid by the connection link 140 in the opening/closing direction in accordance with the rotated position of the door 130.

Meanwhile, although it is illustrated in the drawings that the door 130 has a rotating angle of 90°, there is no limitation thereto, and thus it is possible to form the door 130 to have a rotating angle of more than 90° or a rotating angle of less than 90° depending on the installation environment of the door 130 or when necessary.

Further, in a case where the position of the first hinge axis H1 is disposed in a position outside the door frame 110, it is possible to additionally install a separate support to support the first hinge axis H1, to have the rotation center of the connection link 140 supported.

Hereinafter, operations of the first embodiment of the aforementioned hinged door for utilizing space will be described.

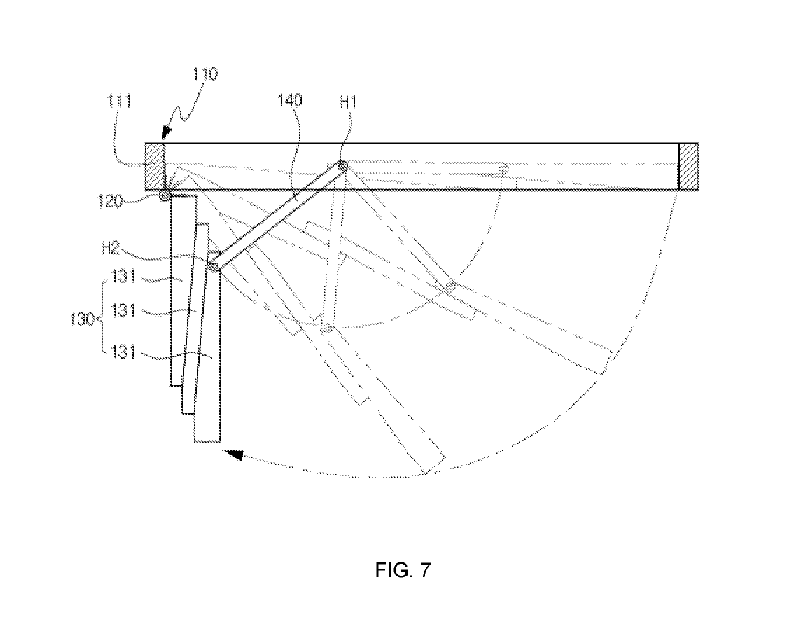

Of the drawings attached, FIG. 7 is a plan configuration view illustrating a state where the door of the hinged door for utilizing space of the present disclosure is open.

First of all, referring to FIG. 5, in a state where the door 130 is closed, the plurality of unit panels 131 constituting the door 130 are coupled slidably to each other in the opening/closing direction of the door 130 as they are coupled to each other at each inclined surface 132 formed on each facing surface by a rail 133 and a siding block 134 that are not illustrated, thereby the panels 131 are stretchable/retractable in the opening/closing direction.

The unit panel 131 arranged at one end of the door 130 is connected to the hinge 120 fixed to the support 111 of the door frame 110 and thus becomes rotatable with regard to the door frame 110, so that the opening can be finished in a hinged manner.

Here, in a state where the plurality of unit panels 131 constituting the door 130 are completely spread and thus the door 130 gets into a closed state, that is, a state where the opening is finished, the ends of the unit panels 131 are disposed to overlap each other, thereby protecting indoor privacy.

Further, in the plurality of unit panels 131 constituting the door 130, by the slidably connected inclined surfaces 132, the thickness of the portion where the ends of the unit panels 131 overlap each other is set to be the same as the thickness of the portion where the inclined surface 132 is not formed. Therefore, since the plurality of unit panels 131 are disposed side by side in a row in a state where the door 130 is closed, that is, when the unit panels 131 are completely spread, it is possible to maintain the thickness of the door 130 at a constant thickness.

Of the plurality of unit panels 131 of the door 130 that finish the opening of the door frame 110 when they are spread, the unit panel 131 arranged at one end of the door is rotatably connected to the support 111 at one side of the door frame 110, by the hinge 120.

Further, of the plurality of unit panels 131, the unit panel 131 arranged at a distal end of the door is connected to the door frame 110 by the connection link 140. To be specific, the first hinge axis H1 at one end of the connection link 140 is rotatably connected to the door frame 110, and the second hinge axis H2 at the other end of the connection link 140 is rotatably connected to the unit panel 131 arranged at the distal end of the door.

Therefore, as illustrated in FIG. 7, when the door 130 is rotated to an open side, the plurality of unit panels 131 constituting the door 130 rotate together around the hinge 120.

Here, in a state where the plurality of unit panels 131 are connected such that they are slidable in the opening/closing direction, since the unit panel 131 arranged at the distal end of the door is connected to the door frame 110 by the connection link 140, the length of the door 130 is adjusted as the plurality of unit panels 131 slide in the opening/closing direction in accordance with the rotated position of the door 130.

That is, in a state where the door 130 is closed, the gap between the hinge 120 and the second hinge axis H2 is D1, and in a state where the door 130 is open, the gap between the hinge 120 and the second hinge axis H2 is D2, which is shorter than D1. Therefore, as the slidably connected plurality of unit panels 131 are slid by the connection link 140 in the opening/closing direction in accordance with the rotated position, the length of the door 130 is adjusted.

In a state where the plurality of unit panels 131 constitute the door 130 and are slidably connected such that they are stretchable/retractable, using the connection link 140, it is possible to make the length of the door 130 to be shorter when it is open than when it is closed in accordance with the rotated position of the door 130.

As mentioned above, according to the present embodiment, the length of the stretchable/retractable door 130 may be adjusted in accordance with the rotated position so that the door is completely spread when closed and completely folded when open, thereby reducing the radius of rotation of the door 130 to make better use of space. In particular, since the length of the door 130 is adjusted as the plurality of unit panels 131 slide, and the ends are disposed in a row in a state where they overlap each other even when completely spread, indoor privacy can be secured.

Next, a hinged door for utilizing space according to the second embodiment of the present disclosure will be described.

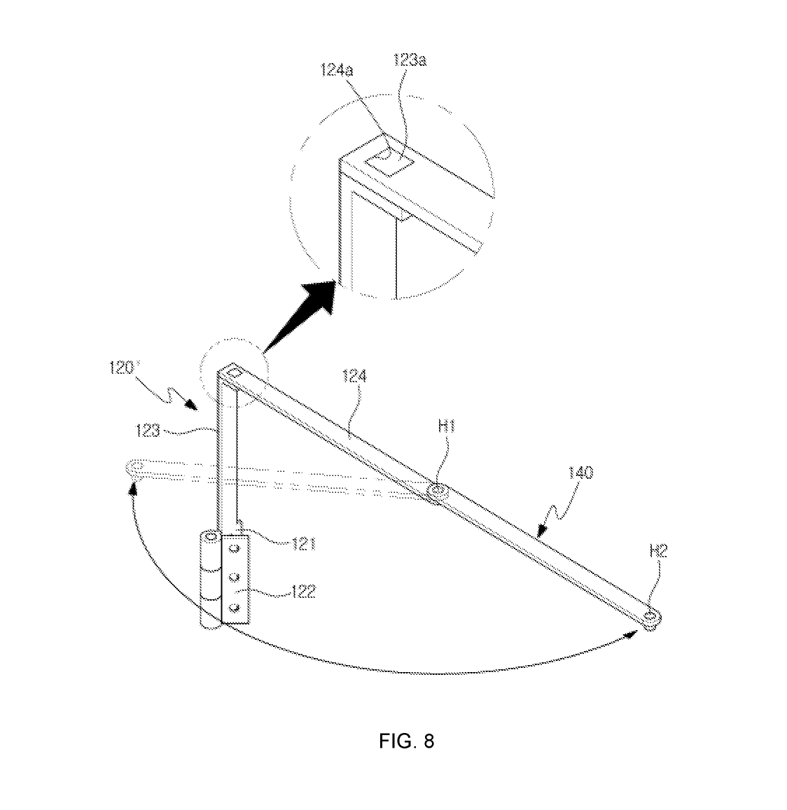

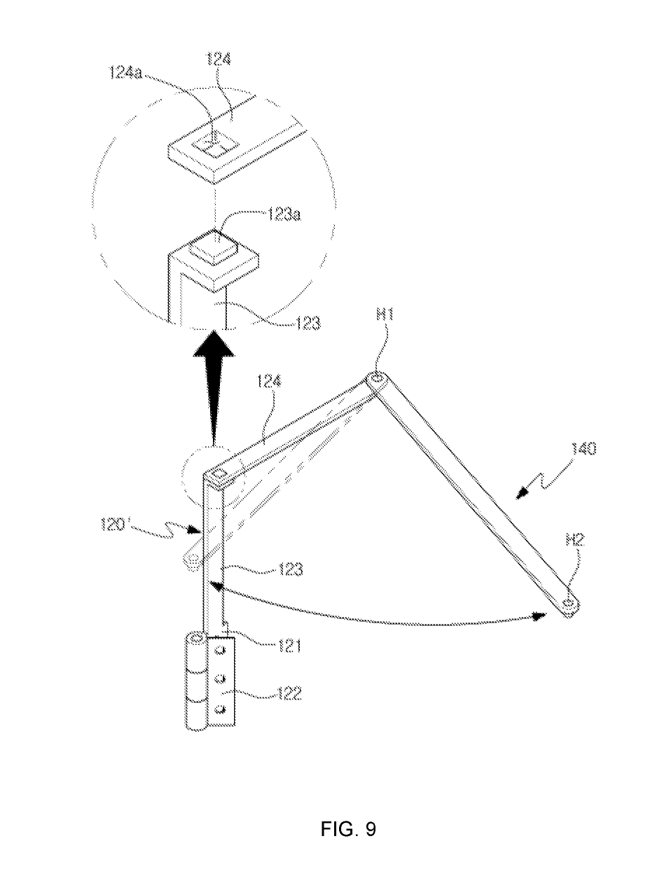

Of the drawings attached, FIG. 8 is a partial perspective view of the hinge according to the second embodiment of the hinged door for utilizing space of the present disclosure, and FIG. 9 is a perspective view illustrating interactions of the hinge according to the second embodiment of the hinged door for utilizing space of the present disclosure.

As illustrated in FIG. 8 and FIG. 9, the hinge 120′ according to the second embodiment of the present disclosure is different from the hinge 120 of the first embodiment in that it includes a first fixed piece 121 fixed to the support 111 at one side of the door frame 110, a second fixed piece 122 rotatably coupled to the first fixed piece 121 and fixed to the door 130, and an extension piece which extends from the first fixing piece 121 and to which the first hinge axis H1 of the connection link 140 is rotatably connected.

To be specific, the extension piece consists of a vertical member 123 that extends in a vertical direction from the first fixed piece 121, and a horizontal member 124 that extends in a horizontal direction from a distal end of the vertical member 123 and that has a distal end to which the first hinge axis H1 is connected.

Further, the horizontal member 124 is configured to adjust a direction extending from a top end of the vertical member 123, and for this purpose, at a top end portion of the vertical member 123, a rectangular-shaped projection 123a for assembling the horizontal member 124 is formed, and at an end of the horizontal member 124, a rectangular-shaped insertion groove 124a is formed to which the projection 123a may be coupled.

Meanwhile, although the present embodiment was described by way of an example that the projection 123a and the insertion groove 124a are formed in rectangular shapes so that the angle of the horizontal member 124 is adjusted by 90°, it is possible to form the projection 123a and the insertion groove 124a in shapes of pentagon or polygon of more angles so that the horizontal member 124 may be adjusted in various angles, or form the horizontal member 124 and the vertical member 123 to have a coupled structure to prevent arbitrary rotation thereof in a state where the horizontal member 124 is coupled to the vertical member 123.

According to such a configuration of the hinge 120, as the extension piece to be connected to the first hinge axis H1 of the connection link 140 is formed integrally with the first fixed piece 121 installed on the support 111 of the door frame 110, the first hinge axis H1 of the connection link 140 may be disposed on a position outside the door frame 110.

Further, since the first hinge axis H1 of the connection link 140 may be supported even when the support of the door frame 110 is not disposed at an upper side of the door 130 just as in a public bathroom where a wall body is formed of a light-weight compartment, the application range of the hinged door for utilizing space of the present disclosure may be expanded.

Meanwhile, since the horizontal member 124 of the extension piece is engaged with the projection 123a of the vertical member 123 extending in a vertical direction from the first fixed piece 121, it is possible to prevent arbitrary rotation or the movement of the horizontal member 124, that may occur during the repeated opening and closing of the door 130.

In particular, in a state where the support of the door frame 110 is not disposed at the upper side of the door 130, the horizontal member 124 of the extension piece is disposed across the opening, and thus the horizontal member 124 may act as an obstructive factor when people pass through the opening.

Therefore, as illustrated in FIG. 9, it is possible to separate the horizontal member 124 from the vertical member 123, and then move the position of the horizontal member 124 in a direction that does not traverse the opening, so that the horizontal member 124 does not act as an obstructive factor when people pass through the opening.

Here, the length of the horizontal member 124 is determined by the position of the first hinge axis H1 which is disposed on an intersecting point of the axis line of the horizontal member 124 and the second segment L2, and in case of the positions of the first hinge axis H1 and the second hinge axis H2 are changed, the length of the connection link 140 must be set such that the connection link 140 connects the first hinge axis H1 and the second hinge axis H2 according to the changed positions of the first hinge axis H1 and the second hinge axis H2, and thus the horizontal members 124 and the connection links 140 having various length and shape may be provided according to the position of the first hinge axis, and also the horizontal member 124 and the connection link 140 that correspond to the position of the first hinge axis and the arrangement of the horizontal member 124 may be selected and installed.

Meanwhile, the present embodiment was described by way of an example that may be applied to a general door 130 installed on a hinge 120 of a support 111 disposed in a vertical direction, but it may also be applied to a large scale door of a garage or a warehouse, installed on a hinge of a support disposed in a horizontal direction at an upper part of an opening, or to a door that opens and closes an opening of furniture such as a sink or a wardrobe.

Next, the hinged door for utilizing space according to the third embodiment of the present disclosure will be described.

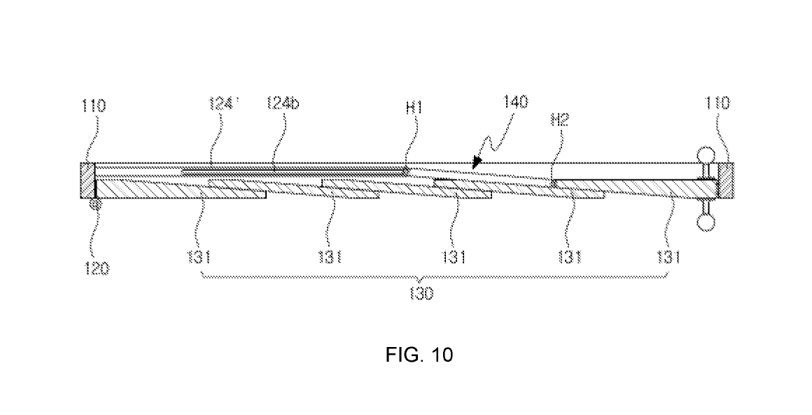

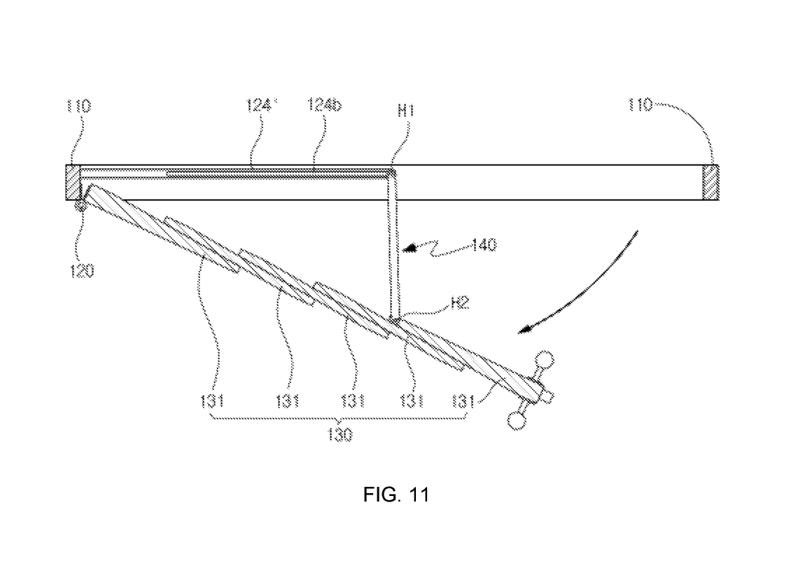

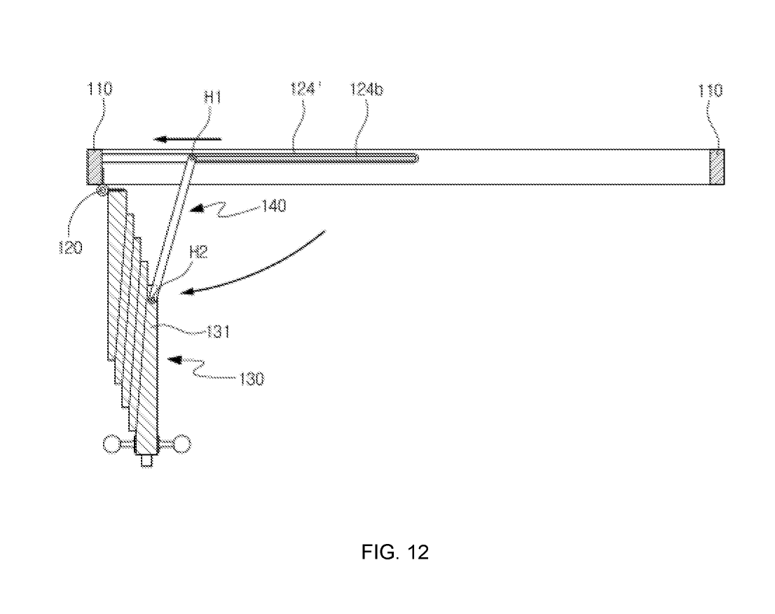

Of the drawings attached, FIG. 10 is a plan configuration view illustrating the third embodiment of the hinged door for utilizing space of the present disclosure, and FIGS. 11 to 12 are interaction views of the third embodiment of the hinged door for utilizing space of the present disclosure.

As illustrated in FIG. 10, the hinged door for utilizing space according to the third embodiment of the present disclosure has a difference in terms of configuration from the aforementioned embodiments in that a rail groove 124b is formed where the first hinge axis H1 may slide across the opening.

According to this configuration, in a state where the horizontal member 124′ having the rail groove 124b formed along a longitudinal direction is disposed across the opening, the horizontal member 124′ is fixed at the door frame 110, and the first hinge axis H1 of the connection link 140 is connected slidably to the rail groove 124b of the horizontal member 124′. In a state where the door 130 configured to be divided into a plurality of unit panels 131 is completely spread, the second hinge axis H2 is connected to the unit panel 131 arranged at the distal end of the door.

In such a state where the plurality of unit panels 131 are completely spread, the opening will be closed by the door 130.

Then, if a handle of the door 130 is pushed or pulled to rotate the door 130 in order to open the door 130, the opening is partially opened as one end of the door 130 rotates about the hinge 120, as illustrated in FIG. 11.

Here, in a state where the plurality of unit panels 131 are connected slidably in the opening/closing direction, the unit panel 131 arranged at the distal end of the door is connected to the horizontal member 124′ side by the connection link 140, and thus, the plurality of unit panels 131 slide in the opening/closing direction in accordance with the rotated position of the door 130, thereby reducing the total length of the door 130.

Next, as illustrated in FIG. 12, the door 130 is pushed or pulled to the opening. When the door 130 rotates about the hinge 120, the first hinge axis H1 of the connection link 140 moves position towards the hinge 120 along the rail groove 124b, and the distance between the hinge 120 and the second hinge axis H2 becomes shorter, whereby the plurality of panels 131 will slide and the length of the door 130 will be reduced.

According to such a configuration, the length of the connection link 140 may be configured relatively shorter than the retracted length of the door 130, and the radius of rotation of the connection link 140 may be minimized, and thus this configuration is effective when applied to a large scale opening or when there are constraints in space for installing the connection link 140.

Meanwhile, although the present embodiment was described by way of an example where the rail groove 124b is fixed-installed in the door frame 110 by a separate horizontal member 124′, it is also possible to provide the rail groove 124b integral with the door frame 110, or to arrange the rail groove 124b at the horizontal member 124 of the hinge 120′ in the second embodiment as illustrated in FIG. 8.

The right of the scope of the present disclosure is not limited to the aforementioned embodiments but may be realized in various types of embodiments within the claims attached hereto. It will be apparent to one of ordinary skill in the art that various changes in form and details may be made in these examples without departing from the spirit and scope of the claims and their equivalents.

### INDUSTRIAL FEASIBILITY

The present disclosure relates to a hinged door for utilizing space, and more particularly, to a hinged door for utilizing space, capable of reducing a radius of rotation of the door to make better use of space, and capable of protecting indoor privacy.

1. A hinged door for utilizing space, comprising:
a hinge installed at one side of an opening of a structure;
a door of which one end is connected to the hinge so as to open and close the opening in a hinged manner as the door is rotated by the hinge, and which is configured to be divided into a plurality of unit panels, each unit panel being slidably connected to an adjacent unit panel in an opening/closing direction so as to stretch/retract in the opening/closing direction; and
a connection link which has a first hinge axis connected to the structure at one end of the connection link and a second hinge axis connected to the unit panel arranged at a distal end of the door at the other end so that a length of the door is stretched/retracted during an opening/closing of the door.

2. The hinged door for utilizing space of claim 1,
wherein the first hinge axis at the one end of the connection link is disposed on a second segment that extends in a direction towards the hinge from a midpoint of a first segment that connects a position of the second hinge axis in a state where the door is completely spread and a position of the second hinge axis in a state where the door is completely folded, the second segment being perpendicular to the first segment.

3. The hinged door for utilizing space of claim 1,
wherein each of the plurality of unit panels has a slidably connected surface, and the surface is configured to be an inclined surface such that the plurality of unit panels are disposed side by side in a row in a state where the door closed the opening.

4. The hinged door for utilizing space of claim 1,
Wherein the plurality of unit panels are configured such that ends of one pair of adjacent unit panels overlap each other in a state where the door closed the opening.

5. The hinged door for utilizing space of claim 3,
Wherein a rail is formed in the opening/closing direction of the door on one of the inclined surfaces of the plurality of unit panels connected slidably to each other, and a sliding block that slides on the rail is formed on the other one of the inclined surfaces.

6. The hinged door for utilizing space of claim 1,
wherein the hinge includes a first fixed piece fixed to one side of the opening of the structure and a second fixed piece rotatably coupled to the first fixed piece and fixed to the door, and an extension piece to which the first hinge axis of the connection link is rotatably connected is integral with the first fixed piece.

7. The hinged door for utilizing space of claim 6,
wherein the extension piece consists of a vertical member that extends in a vertical direction from the first fixed piece and a horizontal member that extends in an horizontal direction from an end of the vertical member and that has an end to which the first hinge axis is connected, and the horizontal member is detachably coupled to the vertical member so that an installation direction is adjusted.

8. The hinged door for utilizing space of claim 7,
wherein a rail groove is formed on the horizontal member along a length of the horizontal member, and the first hinge axis of the connection link is slidably connected to the rail groove.

9. The hinged door for utilizing space of claim 2,
further comprising a rail groove disposed between the hinge and the first hinge axis and fixed to the structure, and the first hinge axis of the connection link is slidably connected to the rail groove.
